(19) United States
(12) Patent Application Publication
(10) Pub. No.: US 2016/0003672 A1
(43) Pub. Date: Jan. 7, 2016

(54) MULTIPLEXER FOR SINGLE PHOTON DETECTOR, PROCESS FOR MAKING AND USE OF SAME

(71) Applicants: VARUN VERMA, BOULDER, CO (US); FRANCESCO MARSILL, PASADENA, CA (US); NATIONAL INSTITUTE OF STANDARDS AND TECHNOLOGY, Gaithersburg, MD (US)

(72) Inventors: SAE WOO NAM, BOULDER, CO (US); JEFFREY STERN, SOUTH PASADENA, CA (US); VAUN VERMA, LAFAYETTE, CO (US); FRANCESCO MARSILI, PASADENA, CA (US)

(21) Appl. No.: 14/801,863

(22) Filed: Jul. 17, 2015

Related U.S. Application Data
(60) Provisional application No. 62/029,139, filed on Jul. 25, 2014.
(60) Provisional application No. 62/035,678, filed on Aug. 11, 2014.

(51) Int. Cl. G01J 1/44; G01J 1/42

(52) U.S. Cl. CPC G01J 1/44; G01J 1/4228; G01J 2001/442

(57) ABSTRACT

An multiplexer includes: a plurality of single photon detectors arranged in a two-dimensional array; a plurality of first bias lines in electrical communication with the single photon detectors; a plurality of second bias lines in electrical communication with the single photon detectors; a plurality of first readout lines in electrical communication with the single photon detectors; and a plurality of second readout lines in electrical communication with the single photon detectors, wherein, for every single photon detector, the first bias line is in electrical communication with the first readout line in a first common line, and for every single photon detector, the second bias line is in electrical communication with the second readout line in a second common line such that the multiplexer is configured for resistive current splitting.

### CROSS REFERENCE TO RELATED APPLICATIONS

This application claims the benefit of U.S. Provisional Patent Application Ser. No. 62/029,139 filed Jul. 25, 2014, and U.S. Provisional Patent Application Ser. No. 62/035,678 filed Aug. 11, 2014, the disclosure of each of which is incorporated herein by reference in its entirety.

### STATEMENT REGARDING FEDERALLY SPONSORED RESEARCH

This invention was made with United States government support from the National Institute of Standards and Technology and in performance of work under NASA contract NNN12AA01C. The government has certain rights in the invention.

### BRIEF DESCRIPTION

Disclosed is a multiplexer comprising: a plurality of single photon detectors arranged in a two-dimensional array; a plurality of first bias lines in electrical communication with the single photon detectors; a plurality of second bias lines in electrical communication with the single photon detectors; a plurality of first readout lines in electrical communication with the single photon detectors; and a plurality of second readout lines in electrical communication with the single photon detectors, wherein, for every single photon detector, the first bias line is in electrical communication with the first readout line in a first common line, and for every single photon detector, the second bias line is in electrical communication with the second readout line in a second common line such that the multiplexer is configured for current splitting.

Also disclosed is a process for making a multiplexer, the process comprising: disposing a plurality of first resistors on a substrate; disposing a plurality of single photon detectors on the substrate, each of the first resistors being in electrical communication with one of the single photon detectors; disposing a plurality of inductors on the substrate, each of the inductors being in electrical communication with one of the first resistors and one of the single photon detectors; forming a plurality of first bias lines in electrical communication with the single photon detectors and comprising the first resistors and the inductors; forming a plurality of first readout lines in electrical communication with the single photon detectors, each of the first readout lines being in electrical communication with one of the first bias lines; forming a plurality of second bias lines in electrical communication with the single photon detectors; and forming a plurality of second readout lines in electrical communication with the single photon detectors to form the multiplexer, each of the second readout lines being in electrical communication with one of the second bias lines.

Further disclosed is a process for detecting a single photon, the process comprising: receiving the single photon by a multiplexer comprising a two dimensional array of single photon detectors; producing a first voltage pulse in response to a state change of a specific single photon detector that received the single photon; and producing a second voltage pulse in response to the state change of the specific single photon detector that received the single photon to detect the single photon.

### BRIEF DESCRIPTION OF THE DRAWINGS

The following descriptions should not be considered limiting in any way. With reference to the accompanying drawings, like elements are numbered alike.

FIG. 1 shows a multiplexer;

FIG. 2 shows a multiplexer;

FIG. 3 shows a multiplexer;

FIG. 4 shows a multiplexer;

FIG. 5 shows a multiplexer;

FIG. 6 shows a multiplexer;

FIG. 7 shows a multiplexer;

FIG. 8 shows a multiplexer;

FIG. 9 shows a multiplexer;

FIG. 10A shows a cross-section of a portion of multiplexer;

FIG. 10B shows a cross-section of a portion of multiplexer;

FIG. 11 shows a graph of voltage and photon arrival versus time;

FIG. 12 shows a graph of voltage and photon arrival versus time;

FIG. 13 shows a graph of voltage and photon arrival versus time;

FIG. 14 shows a graph of voltage and photon arrival versus time;

FIG. 15 shows a graph of voltage and photon arrival versus time;

FIG. 16 shows a graph of voltage and photon arrival versus time;

FIG. 17 shows a graph of voltage and photon arrival versus time;

FIG. 18 shows a graph of voltage and photon arrival versus time;

FIG. 19A shows a top view of a multiplexer according to Example 1;

FIG. 19B shows an enlarged view of a single photon detector shown in FIG. 19A;

FIG. 19C shows an enlarged view of a meander pattern of the single photon detector shown in FIG. 19A;

FIG. 19D shows an enlarged view of an inductor shown in FIG. 19A;

FIG. 19E shows an enlarged view of a resistor shown in FIG. 19A;

FIG. 20 shows a schematic of the multiplexer according to Example 2;

FIG. 21A shows a graph of photon count rate versus bias current according to Example 2;

FIG. 21B shows a graph of photon count rate versus bias current according to Example 2; and

FIG. 22 shows graphs of voltage versus time for the multiplexer shown in FIG. 19A according to Example 3.

### DETAILED DESCRIPTION

A detailed description of one or more embodiments is presented herein by way of exemplification and not limitation.

It has been discovered that a multiplexer provides for detection of single photons incident on a two-dimensional array of single photon detectors. Advantageously, the multiplexer includes common wires to detect incident photons, wherein the common wires is less than a number of the single photon detectors in the two-dimensional array. A location of a photon incident on the two-dimensional array is determined by data from the multiplexer.

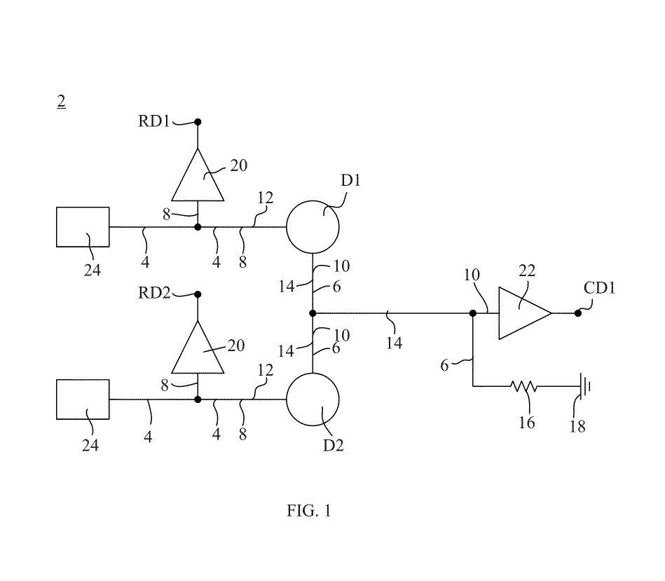

In an embodiment, as shown in FIG. 1, multiplexer 2 includes a plurality of single photon detectors (D1, D2) arranged in a two-dimensional array. A plurality of first bias lines 4 is in electrical communication with single photon detectors (D1, D2), and a plurality of second bias lines 6 is in electrical communication with single photon detectors (D1, D2). A plurality of first readout lines 8 is in electrical communication with single photon detectors (D1, D2), and a plurality of second readout lines 10 is in electrical communication with single photon detectors (D1, D2). Additionally, multiplexer 2 includes a plurality of first common lines 12 and second common line 14. Here, for every single photon detector (D1 and D2), first bias line 4 is in electrical communication with first readout line 8 in first common line 12, and for every single photon detector (D1 and D2), second bias line 6 in electrical communication with second readout line 10 in second common line 14. Accordingly, multiplexer 2 is configured for resistive current splitting of a change in bias current for single photon detectors (D1 and D2) in response to receiving a photon by single photon detector (D1 or D2).

Moreover, multiplexer 2 can include a plurality of current sources 24 to deliver a bias current to single photon detectors (D1, D2) via first bias line 4. The bias current from current source 24 is communicated through first bias line 4, first common line 12, single photon detector (D1 or D2), second common line 14, second bias line 6 to ground 18 when single photon detector is in a first state (cf. a second state). Here, impedance 16 is shown a resistor in FIG. 1 as well as other embodiments herein; however, instead of a resistor, a suitable impedance can be used such as an inductor, a resistor, and the like could to direct the bias current or second voltage pulse to second amplifier 22. In a second state of single photon detector (D1, D2), bias current from current source 24 is effectively blocked from being communicated between first common line 12 and second common line 14 via single photon detector (D1, D2) due to a change in a resistance of single photon detector (D1, D2). The first state of single photon detector (D1, D2) corresponds to an absence of a photon incident at single photon detector (D1, D2). The second state of single photon detector (D1, D2) corresponds to a presence of a photon incident at single photon detector (D1, D2) or a time after the photon incident at single photon detector (D1, D2) but before single photon detector (D1, D2) transitions back to the first state from the second state. When a photon is incident at single photon detector (D1, D2), single photon detector (D1, D2) absorbs the photon and transitions from the first state (in which single photon detector (D1, D2) conducts the bias current between first bias 4 and second bias line 6) to the second state in which single photon detector (D1, D2) effectively does not conduct or decreases conduction of the bias current between first bias 4 and second bias line 6. In a presence of the bias current, a time to transition from the second state to the first state depends on electrical properties of single photon detector (D1, D2) such as inductance and electrical elements in electrical communication with single photon detector (D1, D2), e.g., a resistor, capacitor, inductor, and the like. In a presence of the bias current, when single photon detector (D1, D2) transitions from the first state to the second state, the bias current communicated through single photon detector (D1, D2) decreases, and a first voltage pulse is transmitted from single photon detector (D1, D2) to row output (RD1, RD2) via first common line 12 and first readout line 8. Similarly, when single photon detector (D1, D2) transitions from the first state to the second state, the bias current communicated through single photon detector (D1, D2) decreases, and a second voltage pulse is transmitted from single photon detector (D1, D2) to column output (CD1) via second common line 14 and second readout line 10.

Multiplexer 2 also can include first amplifier 20 in electrical communication with single photon detector (D1 or D2) via first common line 12 and first readout line 8. Second amplifier 22 is in electrical communication with single photon detector (D1 or D2) via second common line 14 and second readout line 10. First amplifier 20 is configured to amplify the first voltage pulse and provide the first voltage pulse as an electrical signal to row output (RD1, RD2), and second amplifier 22 is configured to amplify the second of voltage pulse and to provide the second voltage pulse as an electrical signal to column output (CD1). It is contemplated that a polarity (e.g., a positive going voltage pulse or a negative going voltage pulse) of the first voltage pulse and the second voltage pulse can be an opposite polarity or a same polarity. In an embodiment, the first voltage pulse has a polarity that is different than a polarity of the second voltage pulse.

Here, it should be appreciated that a number of first common lines 12 and single photon detectors (D1, D2) is the same, and a number of second common line 14 is less than the number of single photon detectors (D1, D2). As such, multiplexer 2 multiplexes second voltage pulses produced by single photon detector D1 or single photon detector D2 in second common line 14 and second amplifier 22 to transmit the second voltage pulses to column output CD1 even though single photon detectors (D1, D2) are in electrical communication with two different first common lines 12 and also with row output RD1 and row output RD2, respectively. Hence, a photon received by single photon detector D1 produces a first voltage pulse received at row output RD1 and a second voltage pulse received at column output CD1; however, a photon received by single photon detector D2 produces a first voltage pulse received at row output RD2 and a second voltage pulse received at output CD1. In this manner, multiplexer 2 provides a spatial location and time-of-arrival of single photons incident at the two-dimensional array of single photon detectors (D1, D2).

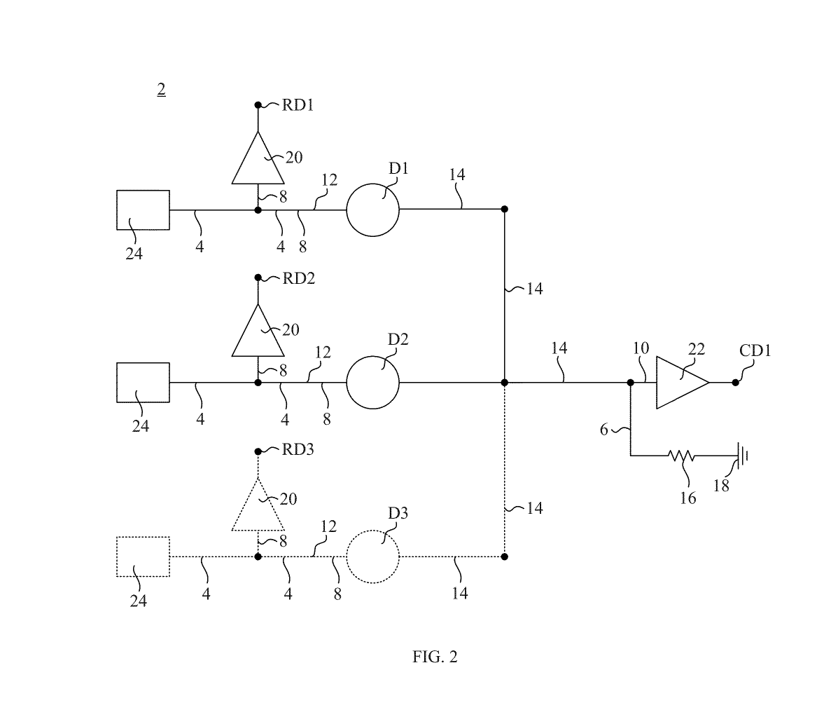

With reference to FIG. 2, in an embodiment, multiplexer 2 includes a plurality of single photon detectors (D1, D2, D3) in electrical communication with a plurality of first common lines 12, a plurality of first amplifiers 20, a plurality of row outputs (RD1, RD2, RD3), second common line 14, second amplifier 22, and column output CD1. For multiplexer 2 shown in FIG. 2, it is contemplated that multiplexer 2 shown in FIG. 1 is extended to have an additional single photon detector D3 and row output RD3 connected via first common line 12 while maintaining second common line 14 and column output CD1. Accordingly, a photon received by single photon detector D1 produces a first voltage pulse received at row output RD1 and a second voltage pulse received at column output CD1; a photon received by single photon detector D2 produces a first voltage pulse received at row output RD2 and a second voltage pulse received at: output CD1; and a photon received by single photon detector D3 produces a first voltage pulse received at row output RD3 and a second voltage pulse received at output CD1. In this manner, multiplexer 2 provides a spatial location and time-of-arrival of single photons incident at the two-dimensional array of single photon detectors (D1, D2, D3).

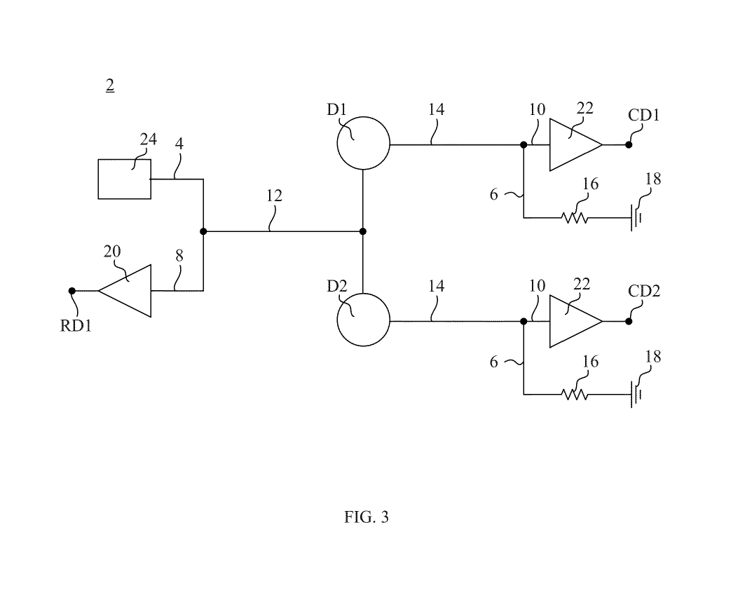

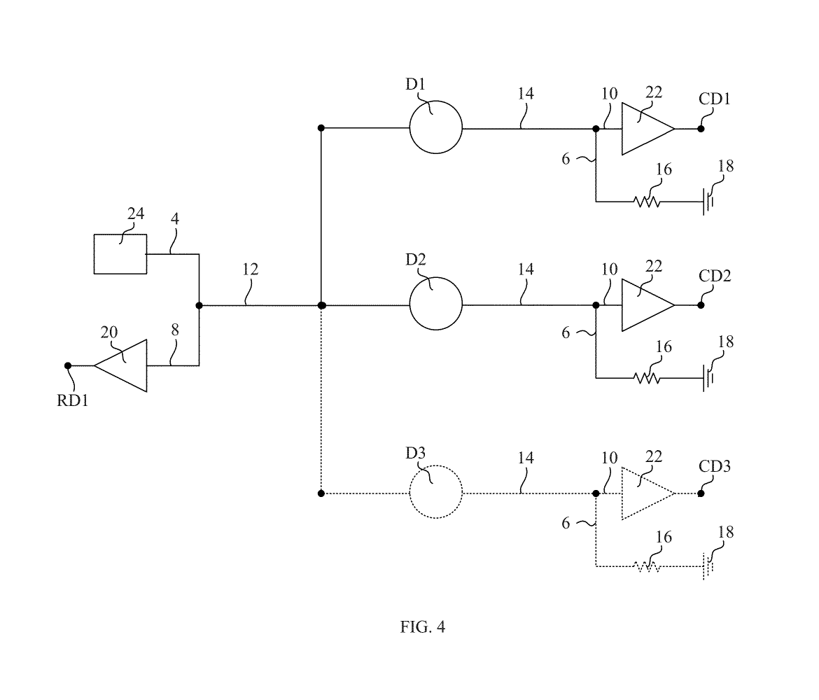

In an embodiment, as show in FIG. 3, multiplexer 2 includes a plurality of single photon detectors (D1, D2) in electrical communication with first common line 12, first amplifier 20, row output RD1, a plurality of second common lines 14, a plurality of second amplifiers 22, and a plurality of column outputs (CD1, CD2). Here, multiplexer 2 includes: common line 12 and row output RD1 to multiplex a first voltage pulse received from single photon detector D1 or single photon detector D2; and the plurality of second common lines 14 and second amplifiers 22 to independently receive a second voltage pulse from single photon detector D1 or a second voltage pulse from single photon detector D2 and respectively transmit the second voltage pulses to column output CD1 and column output CD2. Also, a photon received by single photon detector D1 or D2 produces a first voltage pulse received by first amplifier 20 and row output RD1 and communicated by first common line 12. As such, multiplexer 2 multiplexes first voltage pulses produced by single photon detector D1 or D2 in first common line 12 and first amplifier 20 to transmit the first voltage pulses to row output RD1 even though single photon detectors (D1, D2) are in electrical communication with two different second common lines 14 and also with column output CD1 and column output CD2, respectively. Multiplexer 2 can be extended to include additional single photon detectors (e.g., single photon detector D3), common lines 14, second bias lines 6, second readout lines 10, second amplifiers 22, and column outputs (e.g., column output CD3) as shown in FIG. 4.

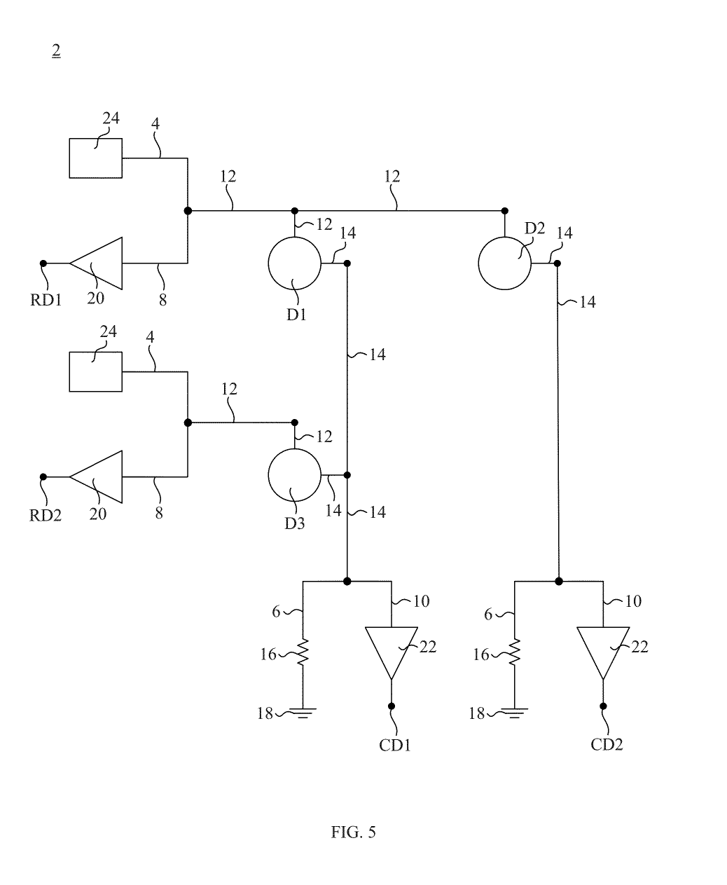

According to an embodiment, as shown in FIG. 5, multiplexer 2 includes a plurality of single photon detectors (D1, D2, D3) in electrical communication with a plurality of first common lines 12 and plurality of second common lines 14. Here, first voltage pulses produced by single photon detectors D1 and D2 are multiplexed in first common line 12 and communicated to row output RD1 via first readout 98 and first amplifier 20. Row output RD2 is configured to receive a first voltage pulse from single photon detector D3. Additionally, second voltage pulses produced by single photon detectors D1 and D3 are multiplexed in second common line 14 that is in electrical communication with second amplifier 22 and received by column output CD1. Column output CD2 is configured to receive a second voltage pulse from single photon detector D2. Accordingly, single photon detector D1 and single photon detector D2 are respectively connected to row outputs RD1 and RD2 and also connected to column output CD1, and single photon detector D2 is connected to row output RD1 and column output CD2. In this manner, multiplexer 2 provides a spatial location and time-of-arrival of single photons incident at the two-dimensional array of single photon detectors (D1, D2, D3) based on a first pulse voltage received at row outputs RD1 or RD2 in combination with a second voltage pulse received at column outputs CD1 or CD2.

For multiplexer 2, it is contemplated that an arrangement of single photon detectors D1 and D2 shown in FIG. 1; single photon detectors D1, D2, and D3 shown in FIG. 2; single photon detectors D1 and D2 shown in FIG. 3; single photon detectors D1, D2, and D3 shown in FIG. 4; and single photon detectors D1, D2, and D3 shown in FIG. 5 is a two-dimensional array of single photon detectors (D1, D2, or D3) because the arrangement includes a plurality of single photon detectors (D1, D2, or D3) in combination with a number of second common lines 14 that is less than a number of single photon detectors (D1, D2, or D3) or in combination with a number of first common lines 12 that is less than the number of single photon detectors (D1, D2, or D3). Hence, the two-dimensional array of single photon detectors (D1, D2, or D3) includes a number of row outputs that is less than the number of single photon detectors; includes a number of column outputs that is less than the number of single photon detectors; or includes a number of column outputs and a number of row outputs that independently are less than the number of single photon detectors in the two-dimensional array of multiplexer 2.

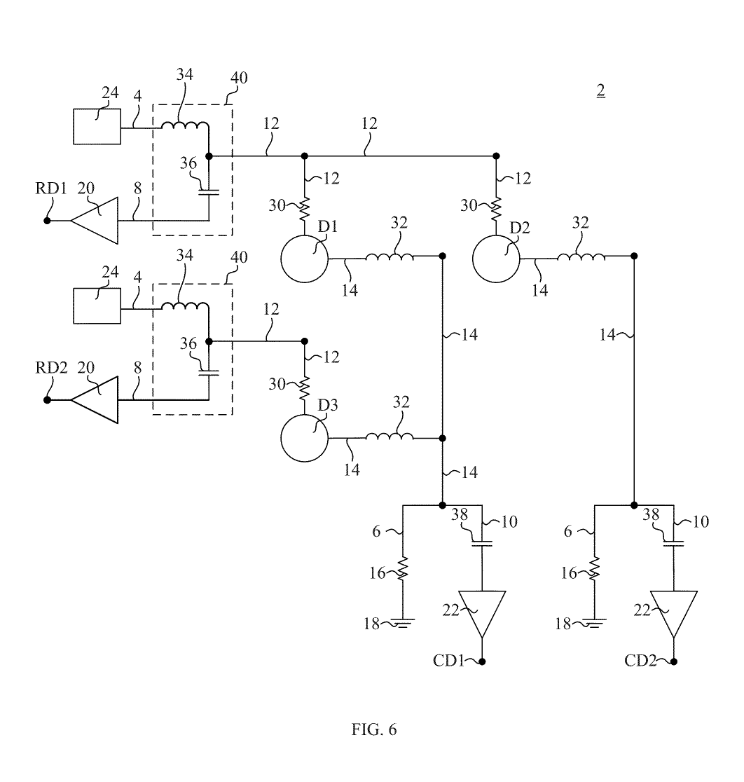

With reference to FIG. 6, in some embodiments, multiplexer 2 includes electrical elements in addition to single photon detector D1 and the like. First common line 12 includes first resistor 30 in series with single photon detectors (D1, D2, D3) such that the bias current provided to single photon detector (D1, D2, or D3) recovers to an amount present in the first state after single photon detector (D1, D2, or D3) transitions to the second state. First resistor 30 also can set a recovery time for multiplexer 2. Second inductor 32 can be included in second common line to reduce leakage current among single photon detectors (D1, D2, D3). Additionally, first inductor 34 can be included in series with current source 24 in first bias line 4 so that the bias current is direct current (DC) substantially free from alternating components in a waveform of the bias current. First capacitor 36 can be interposed in series between first amplifier 20 and first common line 12 to transmit radiofrequency components of the first voltage pulse to row output (RD1, RD2) and eliminate or decrease communication of a DC voltage to first amplifier 20. In some embodiments, first inductor 34 and first capacitor 36 are included in bias tee 40 to connect electrically with current source 24, first amplifier 20, and row output (RD1, RD2) and also first common line 12. Similarly, second capacitor 38 can be interposed in series between second amplifier 22 and second common line 14 to transmit radiofrequency components of the second voltage pulse to column output (CD1, CD2) and eliminate or decrease communication of a DC voltage to second amplifier 22.

In an embodiment, first common line 12 includes first resistor 30 in electrical communication with single photon detector D (e.g., D1, D2, D3), and second bias line 6 includes second impedance 16 in electrical communication with single photon detector D. First bias line 12 further can include inductor 34 in electrical communication with first resistor 30 and single photon detector D. Multiplexer 2 also can include a plurality of first amplifiers 20 electrically connected to the plurality of first readout lines 12 and configured to receive a first voltage pulse from the plurality of single photon detectors D, wherein multiplexer 2 is configured to provide information about a first relative position of a single photon incident on the two dimensional array, based on a specific first amplifier 20 having received the first voltage pulse. Additionally, multiplexer can include a plurality of second amplifiers 22 electrically connected to the plurality of second readout lines 10 and configured to receive a second voltage pulse from the plurality of single photon detectors D, wherein multiplexer 2 is configured to provide information about a second relative position of the single photon incident on the two dimensional array, based on a specific second amplifier 22 having received the second voltage pulse. In some embodiments, multiplexer 2 includes a plurality of current sources 24 in electrical communication with the plurality of first bias lines 12 and configured to provide the bias current to the plurality of first bias lines 12, the bias current being a direct current bias current.

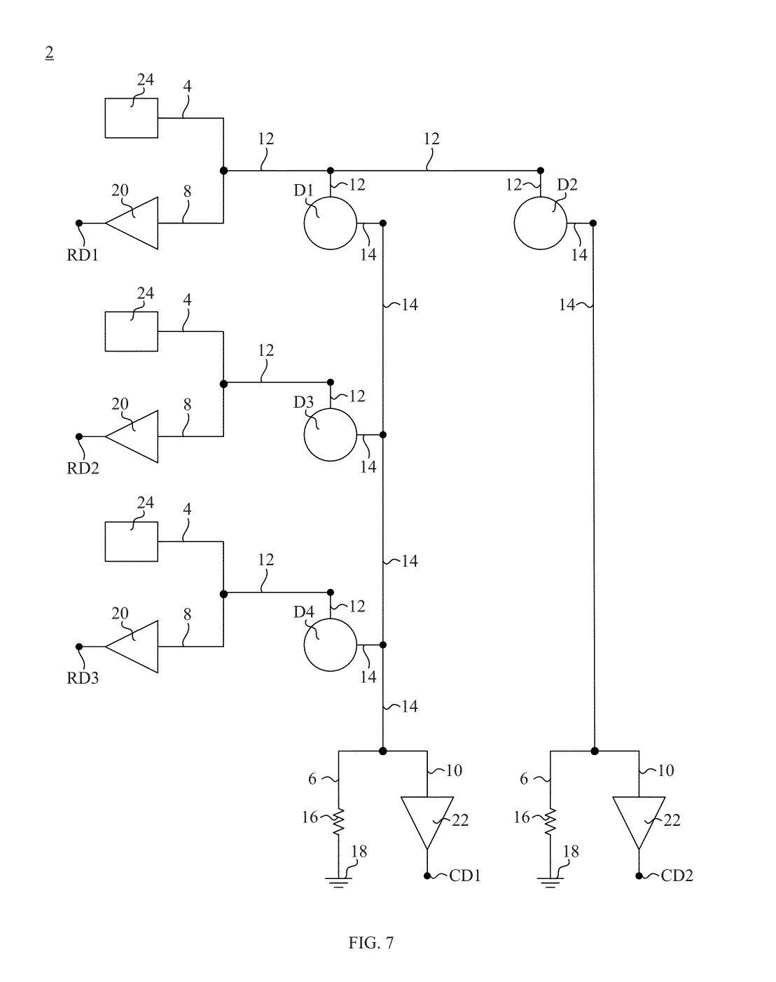

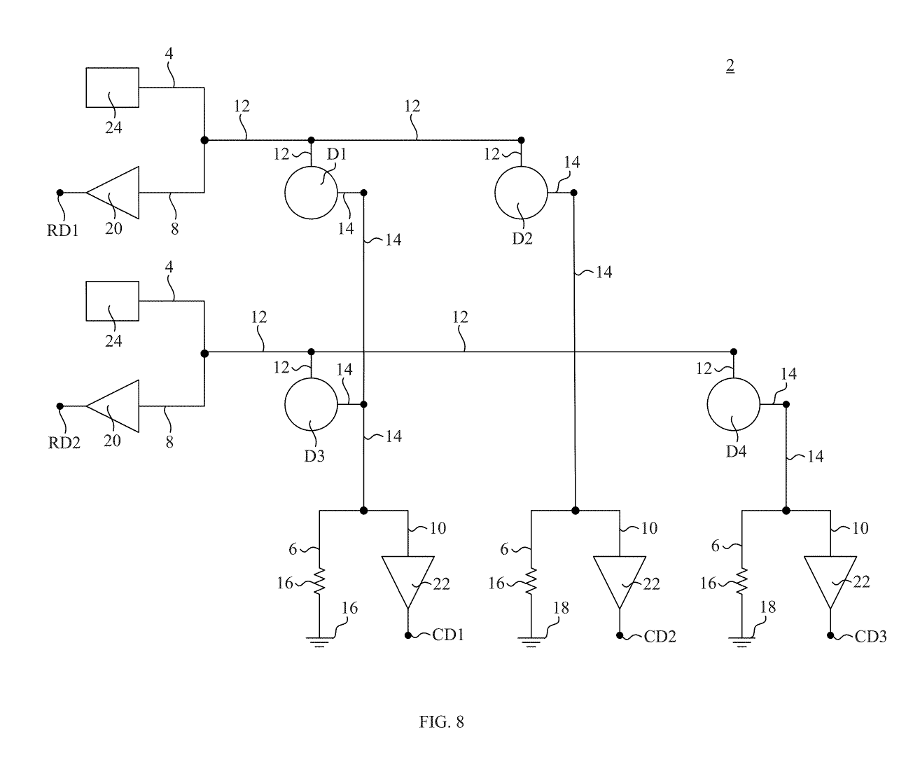

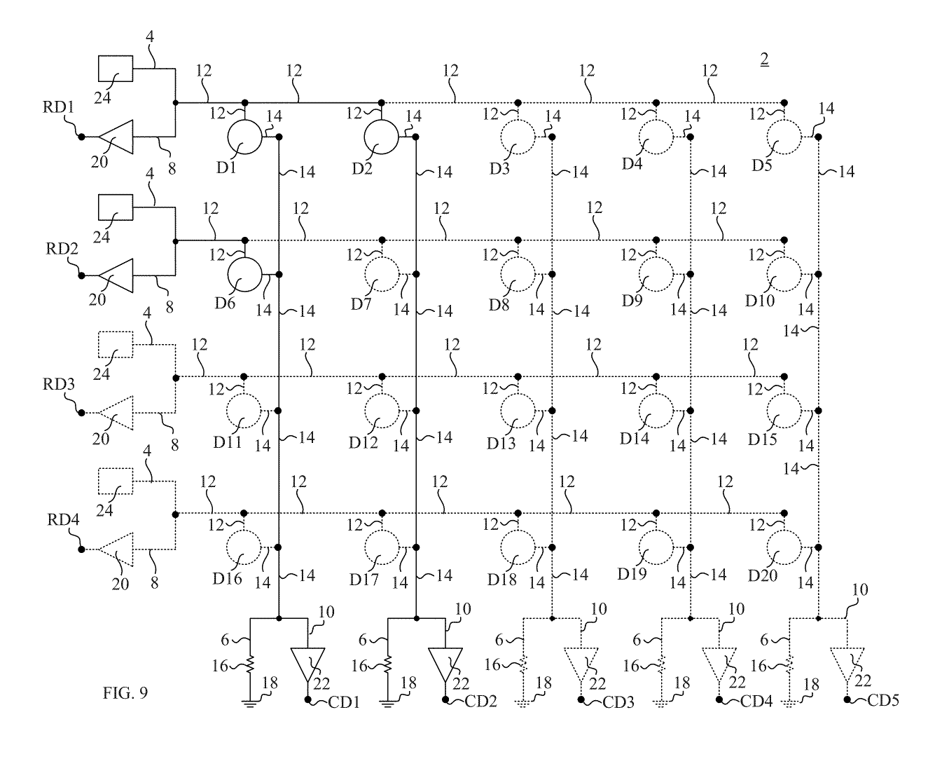

As shown in FIG. 7, FIG. 8, and FIG. 9, a number of row outputs (RD1, RD2, RD3, . . . , RDn, where n is a number of rows in the two-dimensional array of single photon detectors), number of column outputs (RD1, RD2, . . . , RDm, where n is a number of rows in the two-dimensional array of single photon detectors), and single photon detectors (D1, D2, . . . , Dk, where k is a number of single photon detector in the two-dimensional array of single photon detectors) can be selected to provide an array of location sensitive and time sensitive single photon detectors (D1, D2, . . . , Dk,) to detect a location or time-of-arrival of a photon incident on a single photon detector (D1, D2, . . . , Dk) of the two-dimensional array of multiplexer 2.

In an embodiment, multiplexer 2 includes total number k of single photon detectors D (e.g., D1, D2, . . . , or Dk) that is greater than total number m of second common lines 14. Total number k of the single photon detectors can be equal to total number n of first common lines 12.

In a certain embodiment, total number k of single photon detectors (e.g., D1, D2, . . . , or Dk) is greater than total number n of first common lines 12. Total number k of single photon detectors can be equal to total number m of the second common lines. In a particular embodiment, total number k of the single photon detectors is greater than total number m of the second common lines. In multiplexer 2, the two dimensional array is an n×m array, wherein n is an integer number of rows of single photon detectors, and m is an integer number of columns of single photon detectors. In some embodiment, n is greater than 1, and m is greater than 1. Moreover, n can be different than m. However, in certain embodiments, n=m. In a particular embodiment, total number k of the single photon detectors is equal to n×m. In one embodiment, a sum of the number of first common lines 12 and the number of second common lines 14 is equal to n+m. According to an embodiment, total number k of the single photon detectors is less than n×m, wherein the sum of the number of first common lines 12 and the number of second common lines 14 is equal to n+m; or wherein the sum of the number of first common lines 12 and number of second common lines 14 is less than n+m.

In an embodiment, multiplexer 2 is disposed on a substrate. The substrate can include any material on which multiplexer 2 can be disposed. Exemplary materials include a semiconductor, metal, plastic, glass, ceramic, polymer, a combination thereof, and the like. In an embodiment, the substrate includes a semiconductor and oxide thereof. In a certain embodiment, the semiconductor includes silicon, and the oxide includes silicon dioxide.

Single photon detector D includes a superconducting nanowire. According to an embodiment, the superconducting nanowire includes a transition metal, semiconductor, a combination thereof, and the like. Exemplary material for the superconducting nanowire includes W—Si, W—Ge, WCGaGe, WCGaSi, MoGe, Mo—Si, MoRe, W—Re, W—Si—Ge, NbN, NbTiN, and the like. In a particular embodiment, single photon detector D is a superconducting nanowire that includes WSi. Here, single photon detector D that includes the superconducting nanowire has the first state until absorption of a photon that results in a transition from the first state to the second state. The first state is when the superconducting nanowire is superconducting and communicates the bias current between first common line 12 and second common line 14 as described in Verma et al., “A Four-Pixel Single-Photon Pulse-Position Array Fabricated from WSi Superconducting Nanowire Single-Photon Detectors,” Applied Physics Letters 104, 051115 (2014), the disclosure of which is incorporated herein in its entirety. In the first state, the second state is the bias current substantially is equally distributed among single photon detectors D that are in electrical communication via first common line 12 and connected to a same current source 24. When a photon is absorbed by single photon detector D, a normal region or hotspot is produced in the superconducting nanowire that increases an internal resistance of the superconducting nanowire. In a presence of the normal region, the bias current is substantially blocked from flowing between first common line 12 and second common line 14 such that the bias current through single photon detector D is diverted to bias tee 40 and first amplifier 20 where a first voltage pulse is produced in row output RD. Current through second impedance 16 also is reduced to produce the second voltage pulse at column output CD.

In an embodiment, single photon detector D includes the superconducting nanowire that is selected based on a quench of superconductivity of the superconductor, e.g., WSi. It is contemplated that the superconductor is an amorphous superconductor, crystalline superconductor, or combination thereof. In one embodiment, the superconductor includes WSi that is amorphous.

Multiplexer 2 also includes a plurality of wiring. The wiring includes first common line 12, second common line 14, first bias line 4, second bias line 14, first readout line 8, second readout line 10, and the like that independently include an electrical conductor to electrically communicate the bias current, first voltage pulse, second voltage pulse, and the like. Exemplary electrical conductors include a metal, doped semiconductor, conductive composites (e.g., a polymer, glass, and the like), and the like. In an embodiment, the electrical conductor includes a metal such as gold, silver, and the like.

Multiplexer 2 further includes a plurality of resistors (16, 30, and the like). The resistors independently include an electrical resistor to electrically resist communication of the bias current, first voltage pulse, second voltage pulse, or the like. Exemplary electrically resistive material includes metals such as Au, PdAu, Pd, and Ag or superconductors that are resistive at the operation temperature such as W, WSi, MoSi, MoGe, MoGe, Al, or a combination thereof.

Inductors (e.g., 16, 32, 34) can be included in multiplexer 2. Such inductors can be the same material as the nanowire or an appropriate amount of resistive or superconducting material

In an embodiment, a process for making multiplexer 2 includes disposing a plurality of first resistors 30 on substrate 50; disposing a plurality of single photon detectors D on substrate 50, each of first resistors 30 being in electrical communication with one of single photon detectors D; disposing a plurality of inductors 32 on substrate 50, each of inductors 32 being in electrical communication with one of first resistors 30 and one of single photon detectors D; forming a plurality of first bias lines 4 in electrical communication with single photon detectors D and including first resistors 30 and inductors 32; forming a plurality of first readout lines 8 in electrical communication with single photon detectors D, each of first readout lines 8 being in electrical communication with one of first bias lines 4; forming a plurality of second bias lines 6 in electrical communication with single photon detectors D; and forming a plurality of second readout lines 10 in electrical communication with single photon detectors D to form multiplexer 2, each of second readout lines 10 being in electrical communication with one of second bias lines 6.

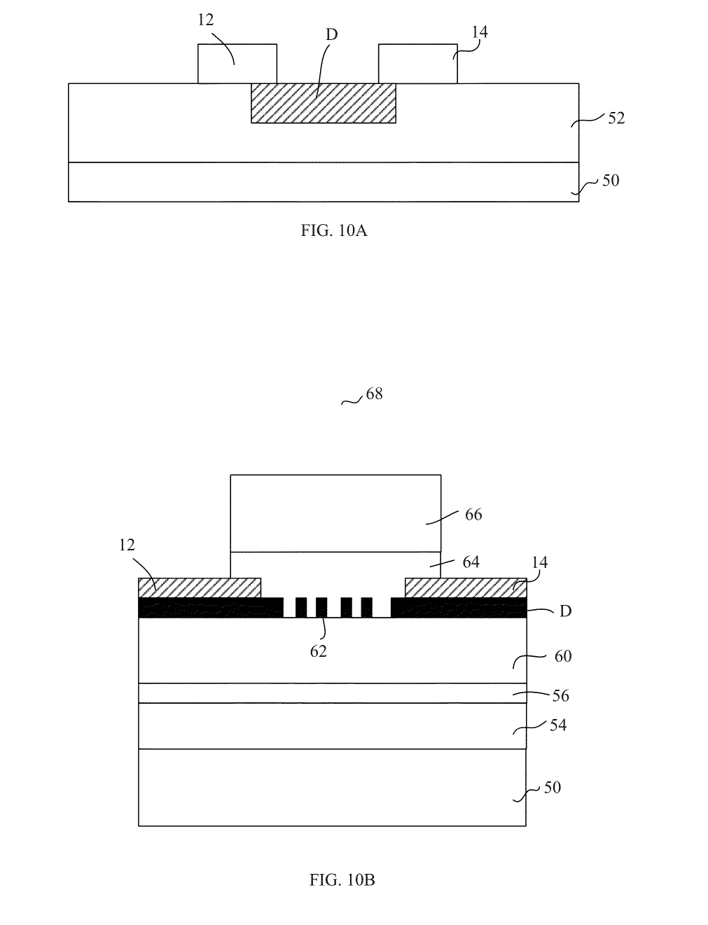

The process can be performed using microelectronic fabrication such as described in Example 1. Further, multiplexer 2 can include additional layers formed on substrate 50 during fabrication. FIG. 10A shows a cross-section of a portion of multiplexer 2 that includes single photon detector D disposed on intermediate layer 52 and substrate 50, first common line 12 in electrical contact with single photon detector D, and second common line 14 in electrical contact with single photon detector D. Intermediate layer 52 can include oxide layer 54, mirror 56, and oxide layer 60 as shown in FIG. 10B. Further, oxide layer 64 or cover layer 66 can be disposed on single photon detector D, which can include a selected pattern such as meander pattern 62. In an embodiment, substrate 50 includes silicon; oxide layer 54 includes silicon dioxide; mirror 56 includes a material (e.g., gold) to provide a reflective surface reflective surface; oxide layer 60 includes silicon dioxide; oxide there 64 includes silicon dioxide; and cover layer 66 includes a material to transmit photons 68 of a selected wavelength (e.g., from 400 nm to 2000 nm) such as titanium dioxide.

Dimensions such as thickness, width, length, and the like of elements of multiplexer 2 can be selected for desired operability condition of multiplexer to such as absorption of a selected wavelength range of photons, a resistivity of resistors (30, 16), and inductance of inductors (34, 32), a superconductivity of single photon detectors D, a sensitivity and amplification of amplifiers (20, 22), and the like.

Exemplary dimension of 62 includes 5 nm thickness, 150 nm wide nanowires patterned to cover a 30 μm×30 μm area.

According to an embodiment, multiplexer 2 is configured to detect a single photon and to multiplex detection of single photon incident on a plurality of single photon detectors D arranged in a two-dimensional array. Here, a process for detecting a single photon includes receiving the single photon by multiplexer 2 that includes the two dimensional array of single photon detectors D; producing a first voltage pulse in response to a state change of a specific single photon detector D that received the single photon; and producing a second voltage pulse in response to the state change of the specific single photon detector D that received the single photon to detect the single photon. The process further includes cooling multiplexer 2 to attain a temperature of single photon detectors D that is less than or equal to a selected temperature below the superconducting transition temperature for the single photon detectors D. In an embodiment, the temperature is less than 3K for single photon detectors D having a superconducting transition temperature of 3K.

The process also can include determining a relative position on the two dimensional array of the single photon based on the first voltage pulse and the second voltage pulse.

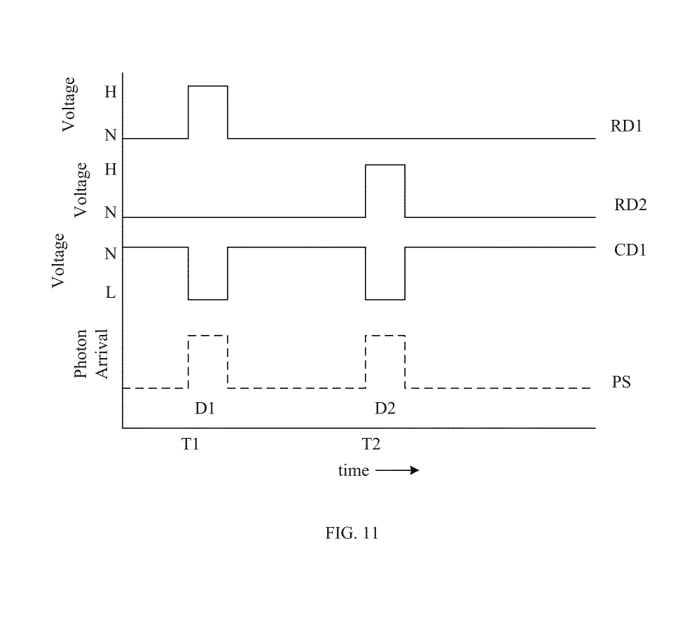

In detecting photons 68, single photon detector D transitions from the first state (e.g., the superconducting state) to the second state (e.g., the resistive state) and produces the first voltage pulse at row output RD and the second voltage pulse at column output CD. From a combination of specific row output RD and specific column output CD, the specific single on detector D and location on the two-dimensional matrix of the photon can be determined. For multiplexer 2 shown in FIG. 1, a timing waveform is shown in FIG. 11 as a graph of voltage of first voltage pulses (having a positive-going pulse amplitude) and second voltage pulses (having a negative-going pulse amplitude) and also photon arrival at single photon detector D versus time. Here, timing waveforms include voltage amplitudes of the first voltage pulse with a value of minimum amplitude at a normal voltage level N and a value of maximum amplitude at a high voltage level H. Timing waveforms also include voltage amplitudes of the second voltage pulse with a value of maximum amplitude at a normal voltage level N and a value of minimum amplitude at a low voltage level L. The normal voltage level N corresponds to the superconducting nanowire of single photon detector D being in the first state in which the superconducting nanowire is superconducting. High voltage level H and low voltage level N correspond to the superconducting nanowire at single photon detector D being in the second state in which the superconducting nanowire has produced a normal region in response to absorption of the single photon. Particularly, in reference to FIG. 1 and FIG. 11, a first photon from photon source PS arrives at single photon detector D1 at time T1 such that single photon detector D1 transitions from the first state to the second state. A first voltage pulse is received at row output RD1, and a second voltage pulse is received at column output CD1 in response to a change in an amplitude of the bias current flowing through single photon detector D1 due to absorption of the first photon. Additionally, a second photon from photon source PS arrives at single photon detector D2 at time T2 such that single photon detector D2 transitions from the first state to the second state, and a first voltage pulse is received at row output RD2 and a second voltage pulse is received at column output CD1 in response to a change in an amplitude of the bias current flowing through single photon detector D2 due to absorption of the second photon. It should be appreciated that first voltage pulses received by row outputs RD1 and RD2 are temporally correlated to second voltage pulses received by column output CD1. In this manner, multiplexer 2 provides the first voltage pulses and the second voltage pulses from which the location of the first photon and the second photon incident on the two-dimensional array of single photon detectors D1 and D2 can be determined as well as a time of arrival of the first photon and second photon at multiplexer 2.

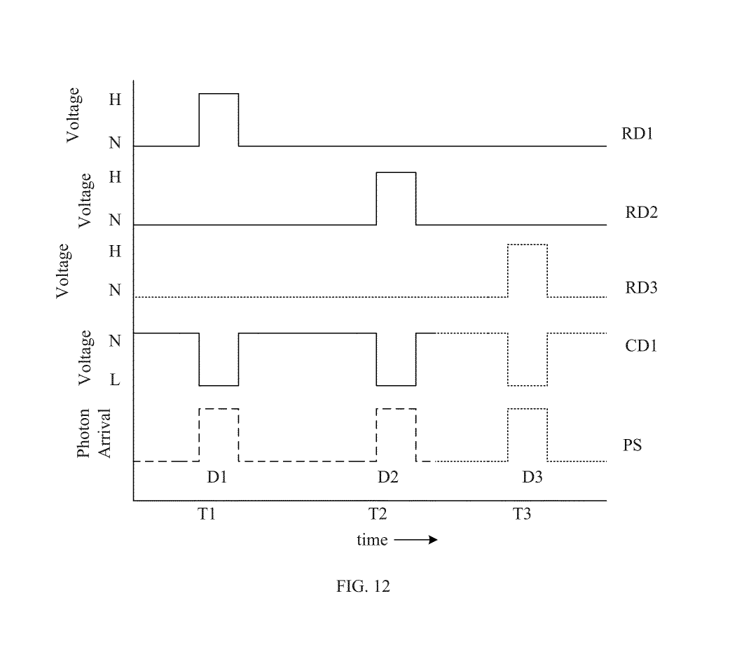

With reference to FIG. 2 and FIG. 12, a first photon from photon source PS arrives at single photon detector D1 at time T1 such that single photon detector D1 transitions from the first state to the second state. A first voltage pulse is received at row output RD1, and a second voltage pulse is received at column output CD1 in response to a change in an amplitude of the bias current flowing through single photon detector D1 due to absorption of the first photon. Additionally, a second photon from photon source PS arrives at single photon detector D2 at time T2 such that single photon detector D2 transitions from the first state to the second state; a first voltage pulse is received at row output RD2, and a second voltage pulse is received at column output CD1 in response to a change in an amplitude of the bias current flowing through single photon detector D2 due to absorption of the second photon. Also, a third photon from photon source PS arrives at single photon detector D3 at time T3 such that single photon detector D3 transitions from the first state to the second state; a first voltage pulse is received at row output RD3, and a second voltage pulse is received at column output CD1 in response to a change in an amplitude of the bias current flowing through single photon detector D3 due to absorption of the second photon. It should be appreciated that first voltage pulses received by row outputs RD1, RD2, and RD3 are temporally correlated to second voltage pulses received by column output CD1. In this manner, multiplexer 2 provides the first voltage pulses and the second voltage pulses from which the location of the first photon, second photon, and the third photon incident on the two-dimensional array of single photon detectors D1, D2, and D3 can be determined as well as a time of arrival of the first, second, and third photons at multiplexer 2.

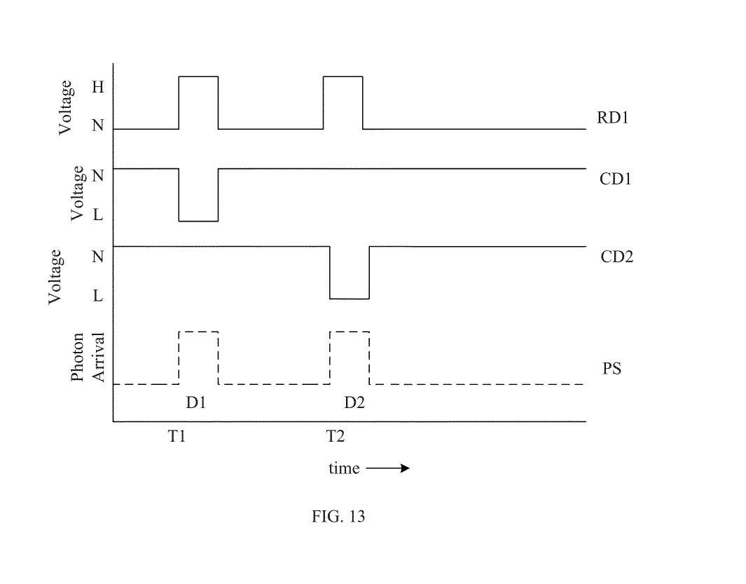

With reference to FIG. 3 and FIG. 13, a first photon from photon source PS arrives at single photon detector D1 at time T1 such that single photon detector D1 transitions from the first state to the second state. A first voltage pulse is received at row output RD1, and a second voltage pulse is received at column output CD1 in response to a change in an amplitude of the bias current flowing through single photon detector D1 due to absorption of the first photon. Additionally, a second photon from photon source PS arrives at single photon detector D2 at time T2 such that single photon detector D2 transitions from the first state to the second state, and a first voltage pulse is received at row output RD1 and a second voltage pulse is received at column output CD2 in response to a change in an amplitude of the bias current flowing through single photon detector D2 due to absorption of the second photon. It should be appreciated that first voltage pulses received by row outputs RD1 are temporally correlated to second voltage pulses received by column outputs CD1 and CD2. In this manner, multiplexer 2 provides the first voltage pulses and the second voltage pulses from which the location of the first photon and the second photon incident on the two-dimensional array of single photon detectors D1 and D2 can be determined as well as a time of arrival of the first photon and second photon at multiplexer 2.

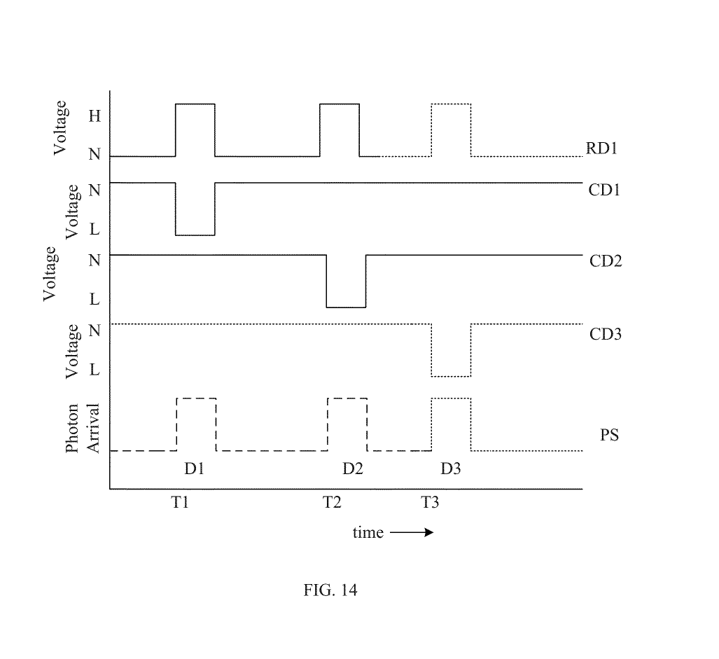

With reference to FIG. 4 and FIG. 14, a first photon from photon source PS arrives at single photon detector D1 at time T1 such that single photon detector D1 transitions from the first state to the second state. A first voltage pulse is received at row output RD1, and a second voltage pulse is received at column output CD1 in response to a change in an amplitude of the bias current flowing through single photon detector D1 due to absorption of the first photon. Additionally, a second photon from photon source PS arrives at single photon detector D2 at time T2 such that single photon detector D2 transitions from the first state to the second state; a first voltage pulse is received at row output RD1, and a second voltage pulse is received at column output CD2 in response to a change in an amplitude of the bias current flowing through single photon detector D2 due to absorption of the second photon. Also, a third photon from photon source PS arrives at single photon detector D3 at time T3 such that single photon detector D3 transitions from the first state to the second state; a first voltage pulse is received at row output RD1, and a second voltage pulse is received at column output CD3 in response to a change in an amplitude of the bias current flowing through single photon detector D3 due to absorption of the second photon. It should be appreciated that first voltage pulses received by row output RD1 are temporally correlated to second voltage pulses received by column outputs CD1, CD2, and CD3. In this manner, multiplexer 2 provides the first voltage pulses and the second voltage pulses from which the location of the first photon, second photon, and the third photon incident on the two-dimensional array of single photon detectors D1, D2, and D3 can be determined as well as a time of arrival of the first, second, and third photons at multiplexer 2.

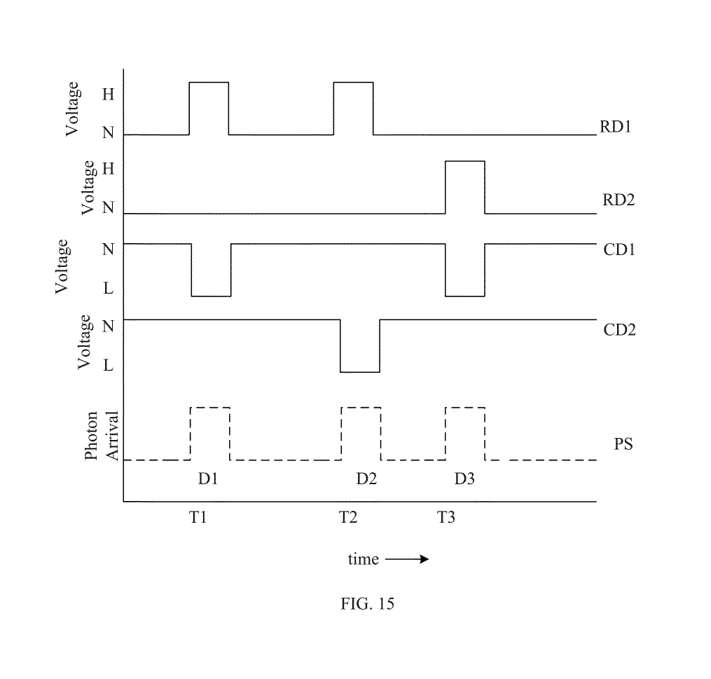

With reference to FIG. 5 and FIG. 15, a first photon from photon source PS arrives at single photon detector D1 at time T1 such that single photon detector D1 transitions from the first state to the second state. A first voltage pulse is received at row output RD1, and a second voltage pulse is received at column output CD1 in response to a change in an amplitude of the bias current flowing through single photon detector D1 due to absorption of the first photon. Additionally, a second photon from photon source PS arrives at single photon detector D2 at time T2 such that single photon detector D2 transitions from the first state to the second state; a first voltage pulse is received at row output RD1, and a second voltage pulse is received at column output CD2 in response to a change in an amplitude of the bias current flowing through single photon detector D2 due to absorption of the second photon. Also, a third photon from photon source PS arrives at single photon detector D3 at time T3 such that single photon detector D3 transitions from the first state to the second state; a first voltage pulse is received at row output RD2, and a second voltage pulse is received at column output CD1 in response to a change in an amplitude of the bias current flowing through single photon detector D3 due to absorption of the second photon. It should be appreciated that first voltage pulses received by row outputs RD1 and RD2 are temporally correlated to second voltage pulses received by column outputs CD1 and CD2. In this manner, multiplexer 2 provides the first voltage pulses and the second voltage pulses from which the location of the first photon, second photon, and the third photon incident on the two-dimensional array of single photon detectors D1, D2, and D3 can be determined as well as a time of arrival of the first, second, and third photons at multiplexer 2.

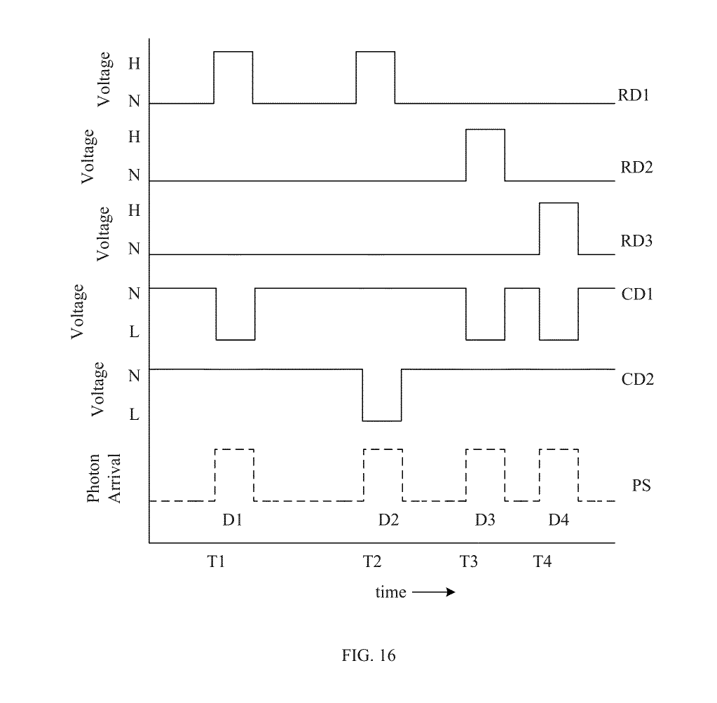

With reference to FIG. 7 and FIG. 16, a first photon from photon source PS arrives at single photon detector D1 at time T1 such that single photon detector D1 transitions from the first state to the second state. A first voltage pulse is received at row output RD1, and a second voltage pulse is received at column output CD1 in response to a change in an amplitude of the bias current flowing through single photon detector D1 due to absorption of the first photon. Additionally, a second photon from photon source PS arrives at single photon detector D2 at time T2 such that single photon detector D2 transitions from the first state to the second state; a first voltage pulse is received at row output RD1, and a second voltage pulse is received at column output CD2 in response to a change in an amplitude of the bias current flowing through single photon detector D2 due to absorption of the second photon. Also, a third photon from photon source PS arrives at single photon detector D3 at time T3 such that single photon detector D3 transitions from the first state to the second state; a first voltage pulse is received at row output RD2, and a second voltage pulse is received at column output CD1 in response to a change in an amplitude of the bias current flowing through single photon detector D3 due to absorption of the second photon. Further, a fourth photon from photon source PS arrives at single photon detector D4 at time T4 such that single photon detector D4 transitions from the first state to the second state; a first voltage pulse is received at row output RD3, and a second voltage pulse is received at column output CD1 in response to a change in an amplitude of the bias current flowing through single photon detector D4 due to absorption of the second photon. It should be appreciated that first voltage pulses received by row outputs RD1, RD2, and RD3 are temporally correlated to second voltage pulses received by column outputs CD1 and CD2. In this manner, multiplexer 2 provides the first voltage pulses and the second voltage pulses from which the location of the first photon, second photon, third photon, and fourth photon incident on the two-dimensional array of single photon detectors D1, D2, D3, and D4 can be determined as well as a time of arrival of the first, second, third, and fourth photons at multiplexer 2.

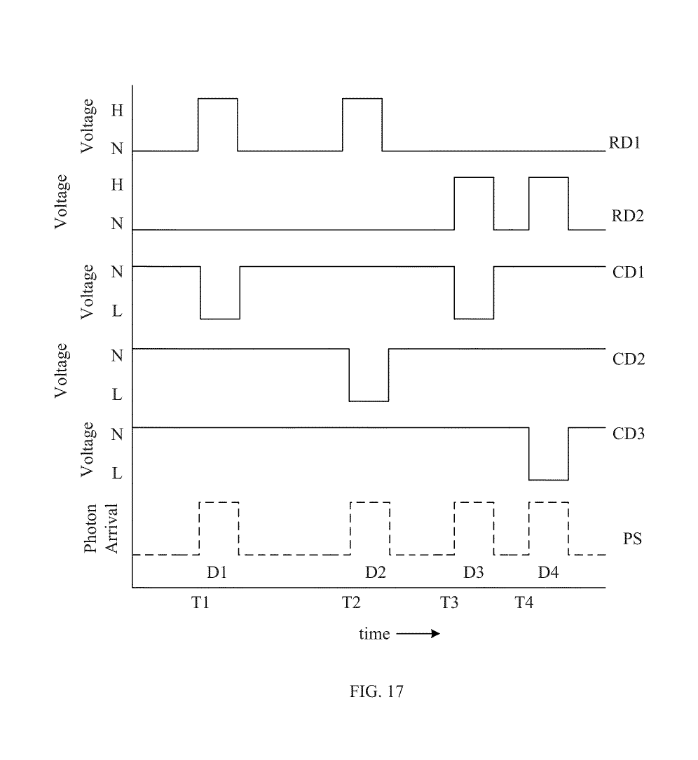

With reference to FIG. 8 and FIG. 17, a first photon from photon source PS arrives at single photon detector D1 at time T1 such that single photon detector D1 transitions from the first state to the second state. A first voltage pulse is received at row output RD1, and a second voltage pulse is received at column output CD1 in response to a change in an amplitude of the bias current flowing through single photon detector D1 due to absorption of the first photon. Additionally, a second photon from photon source PS arrives at single photon detector D2 at time T2 such that single photon detector D2 transitions from the first state to the second state; a first voltage pulse is received at row output RD1, and a second voltage pulse is received at column output CD2 in response to a change in an amplitude of the bias current flowing through single photon detector D2 due to absorption of the second photon. Also, a third photon from photon source PS arrives at single photon detector D3 at time T3 such that single photon detector D3 transitions from the first state to the second state; a first voltage pulse is received at row output RD2, and a second voltage pulse is received at column output CD1 in response to a change in an amplitude of the bias current flowing through single photon detector D3 due to absorption of the second photon. Further, a fourth photon from photon source PS arrives at single photon detector D4 at time T4 such that single photon detector D4 transitions from the first state to the second state; a first voltage pulse is received at row output RD2, and a second voltage pulse is received at column output CD3 in response to a change in an amplitude of the bias current flowing through single photon detector D4 due to absorption of the second photon. It should be appreciated that first voltage pulses received by row outputs RD1, and RD2 are temporally correlated to second voltage pulses received by column outputs CD1, CD2, and CD3. In this manner, multiplexer 2 provides the first voltage pulses and the second voltage pulses from which the location of the first photon, second photon, third photon, and fourth photon incident on the two-dimensional array of single photon detectors D1, D2, D3, and D4 can be determined as well as a time of arrival of the first, second, third, and fourth photons at multiplexer 2.

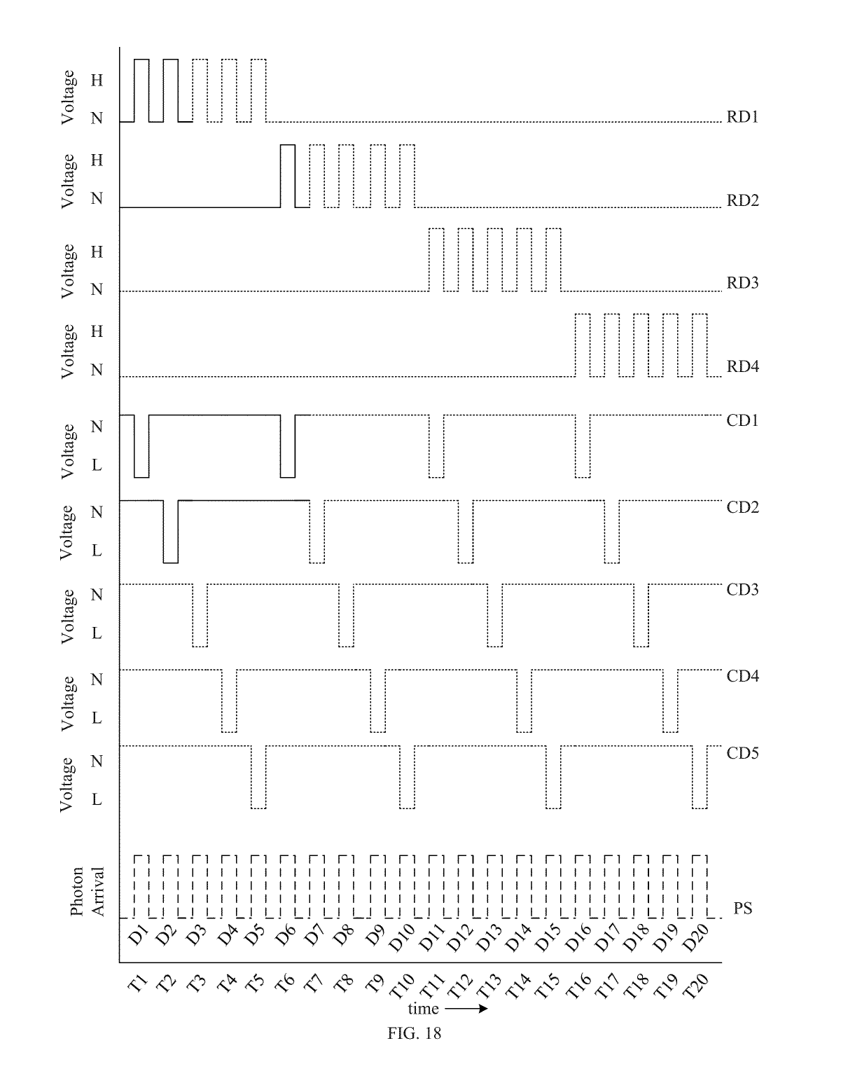

With reference to FIG. 9 and FIG. 18, a plurality of photons arrive at multiplexer 2. Table 1 lists an arrival time (T1, . . . , T20) of photons at single photon detectors (D1, . . . , D20), row outputs (RD1, . . . , RD4), and column outputs (CD1, . . . , CD5). It should be appreciated that first voltage pulses received by row outputs (RD1, . . . , RD4) are temporally correlated to second voltage pulses received by column outputs (CD1, . . . , CD5). In this manner, multiplexer 2 provides the first voltage pulses and the second voltage pulses from which the location of the plurality of photons incident on the two-dimensional array of single photon detectors (D1, . . . , D20) can be determined as well as a time of arrival of the photons at multiplexer 2.

TABLE 1

| | Single photon | Row output | Column output |
|---|---|---|---|
| Time | detector D | RD | CD |
| T1 | D1 | RD1 | CD1 |
| T2 | D2 | RD1 | CD2 |
| T3 | D3 | RD1 | CD3 |
| T4 | D4 | RD1 | CD4 |
| T5 | D5 | RD1 | CD5 |
| T6 | D6 | RD2 | CD1 |
| T7 | D7 | RD2 | CD2 |
| T8 | D8 | RD2 | CD3 |
| T9 | D9 | RD2 | CD4 |
| T10 | D10 | RD2 | CD5 |
| T11 | D11 | RD3 | CD1 |
| T12 | D12 | RD3 | CD2 |
| T13 | D13 | RD3 | CD3 |
| T14 | D14 | RD3 | CD4 |
| T15 | D15 | RD3 | CD5 |
| T16 | D16 | RD4 | CD1 |
| T17 | D17 | RD4 | CD2 |
| T18 | D18 | RD4 | CD3 |
| T19 | D19 | RD4 | CD4 |
| T20 | D20 | RD4 | CD5 |

It has been found that multiplexer 2 has size that is scalable. It is contemplated that a scalability of multiplexer 2 persists when a signal from the row output and column output is greater than noise from multiplexer 2 that interferes with acquiring the signal. Multiplexer 2 has numerous advantages and benefits that include high signal-to-noise for row outputs and column outputs, ultra-fast and low jitter signals, and ease of fabrication.

Further, multiplexer 2 can be used in various environments such as semiconductor fabrication characterization, property characterization of various materials, LIDAR, medical, greenhouse gas Detection, remote sensing, single photon imaging, single photon spectroscopy arrays, research tools, ultra-long distance communication, long distance quantum communications, quantum information, single photonics, quantum wells, quantum wires, quantum dots, ion detection, mass spectrometry, and the like. Beneficially, multiplexer 2 includes fewer wirings than a single photon detector array that does not include first common line 12 or second common line 14, reduced heat load for a cryogenic system, larger surface area for single photon detection and coupling incident light onto the two-dimensional array, row outputs and column outputs to identify an incident location of a photon, higher count rate than a single pixel detector, inexpensive packaging for adoption of a superconducting detector, relatively inexpensive for production of multiplexer 2, robust packaging, and the like.

A signal-to-noise of row output RD or column output CD can be a function of a maximum value of the bias current for each single photon detector and the noise of the amplifiers (e.g., 20 or 22). The jitter of the first voltage pulse or second voltage pulse is related to the signal to noise ratio but should approach the jitter of a single photon detector D if the single photon detector D was operated individually. A recovery time of single photon detectors D can be a function of the materials of construction of multiplexer 2 and elements electrically connected to single photon detectors D, which can be in the nanosecond time scale. A wavelength of photons received by multiplexer 2 for production of the first voltage pulse and the second voltage pulse can be from ultraviolet to mid infrared, specifically from 100 nm to 10 μm. A detection efficiency of multiplexer 2 can approach 100%.

The articles and processes herein are illustrated further by the following Examples, which are non-limiting.

### EXAMPLES

### Example 1

### Multiplexer

A multiplexer was fabricated on a silicon wafer with 150 nm of thermally grown SiO₂ on top. Contact pads and resistors were patterned and deposited in the same step and included 2 nm T1 and 50 nm Au. The wafer was cleaned in an O₂ plasma, and a superconducting WSi film (included ˜25% Si, 4.6 nm thick, and Tc ˜3.4 K) was deposited by DC magnetron cosputtering from separate W and Si targets at room temperature. The WSi film was amorphous; reduced carrier density and larger hotspot size so that the nanowires were produced with a selective width that could be wider than NbN-based nanowires; a saturation of internal detection efficiency over a wide range of bias current to provide the multiplexer to be subject to the bias current below a switching current of the single photon detectors without sacrificing efficiency.

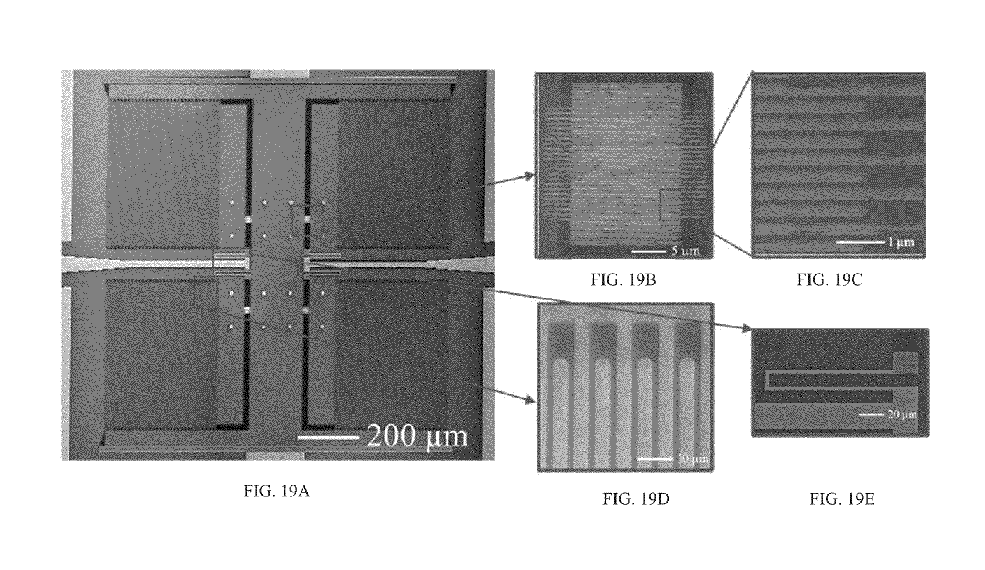

After deposition of the WSi, the layer was patterned by optical lithography into a stripe of 20 μm width on which the single photon detector was patterned. An inductor (which had 3.5 times an inductance of the single photon detector) also was patterned at this time and had wires with a width of 1.5 μm and a 6 μm pitch that covered an area of 500 μm by 375 μm. After optical lithography, the WSi film was etched in an SF₆ plasma. Finally, electron-beam lithography and SF6 etching were used to pattern the single photon detectors into 20 μm wide strips of Wsi nanowires that had a meander pattern. The single photon detectors included a meander pattern of 140 nm wide nanowires with a pitch of 360 nm that covered a surface area of 16 μm×16 μm. A total kinetic inductance LT (LT=Lk+Li) per single photon detector and inductor connected thereto was approximately 4 pH. FIG. 19A shows a scanning electron micrograph of a portion of the multiplexer that included the inductor, resistor, and single photon detectors. Single photon detectors were subjected to the bias current through bias lines for each column on the left and right sides of the micrograph. FIG. 19B shows an enlarged view of a single photon detector shown in FIG. 19A. FIG. 19C shows an enlarged portion of the single photon detector shown in FIG. 19B. FIG. 19D shows an enlarged view of an inductor shown in FIG. 19A. FIG. 19E shows an enlarged view of a resistor shown in FIG. 19A.

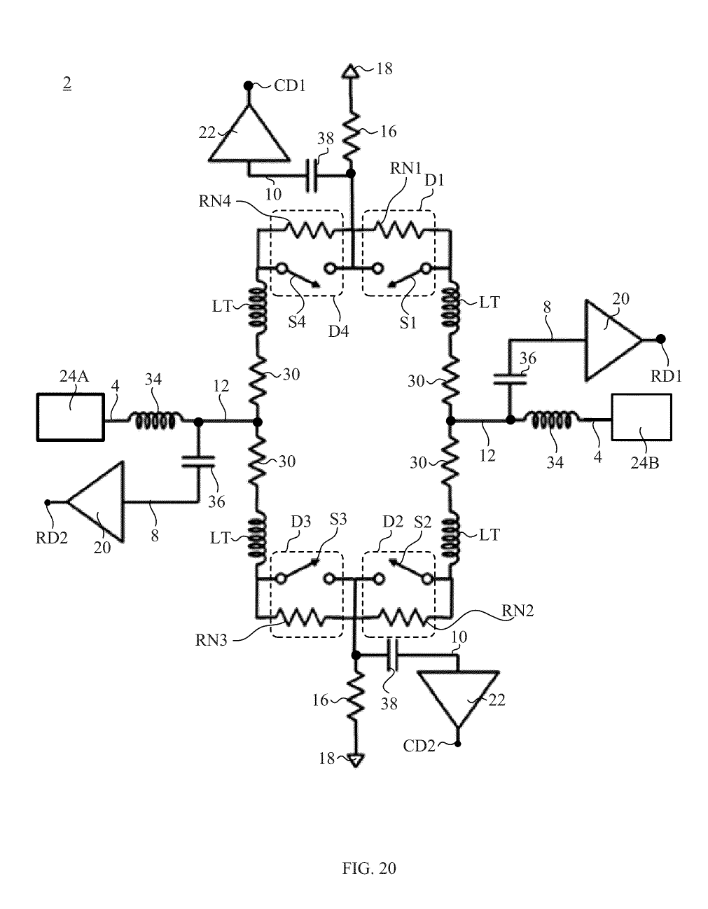

FIG. 20 shows an equivalent circuit diagram for the multiplexer in which

single photon detectors (D1, D2, D3, D4) were subjected to bias current IB through a bias tee in each column of single photon detectors (D1 and D2; D3 and D4) such that a pixel included first resistor 30 followed by single photon detector (D1, D2, D3, or D4 with kinetic inductance Lk) and an additional inductor Li to provide an equivalent inductor LT. Here, single photon detectors (D1, D2, D3, D4) are shown as electrical switch (S1, S2, S3, S4) in parallel with resistor (RN1, RN2, RN3, RN4). When single photon detector (D1, D2, D3, D4) was in the first state, electrical switch (S1, S2, S3, S4) was closed, shorting respective resistor (RN1, RN2, RN3, RN4) such that bias current IB was equally distributed between among single photon detector (D1 and D2; D3 and D4) in a same column. When a photon was absorbed by single photon detector (D1, D2, D3, D4), a normal region was generated in the nanowire, and electrical switch (S1, S2, S3, S4) opened, which diverted the bias current into resistor (RN1, RN2, RN3, RN4). Here, RN>>first resistor 30 (which was 25Ω in series with the total inductance LT=Lk+Li. The value of RN (for RN1, RN2, RN3, RN4) was 1 kΩ such that bias current was diverted to amplifier 24A or 24B where a voltage pulse was produced in a row output RD1 or RD2 and column output CD1 or CD2.

### Example 2

### Multiplexer Photon Counts

The multiplexer of Example 1 was

patterned on-chip, except for bias tees and amplifiers (20, 22), which were located outside of a cryostat at room temperature. The total gain of the amplifier chain was 51.5 dB. With respect to single photon detectors (D1, D2, D3, D4), we refer to the top row, bottom row, right column, and left column using the cardinal directions (North, South, East, and West, respectively).

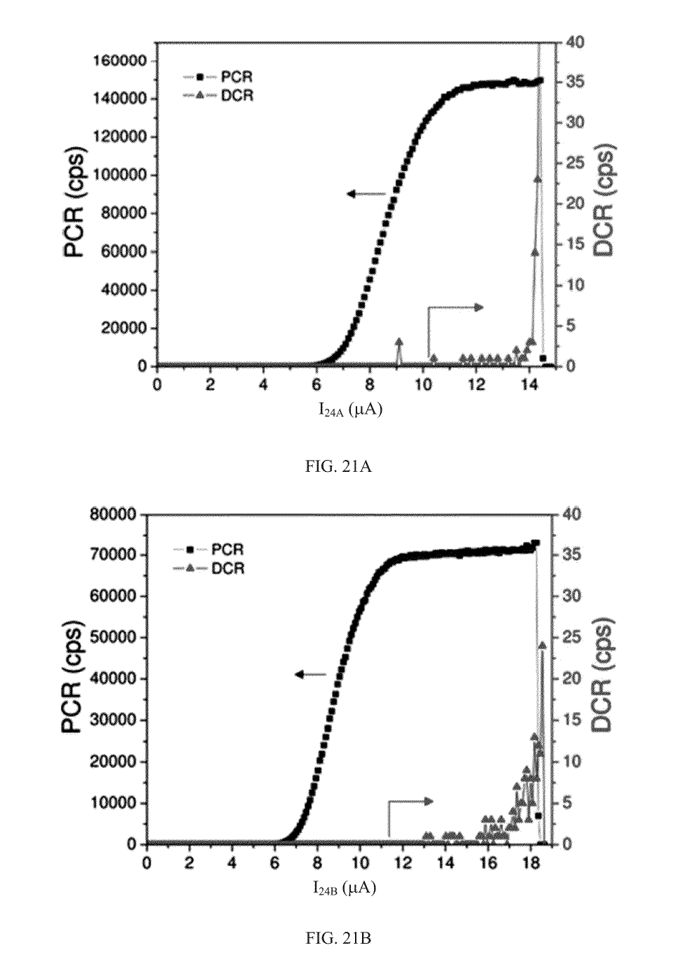

The multiplexer was cooled to a temperature of 250 mK in an adiabatic demagnetization refrigerator for measurement of switching current and optical response. The multiplexer was flood-illuminated at a wavelength of 1550 nm by a single-mode optical fiber positioned ˜8 mm from the chip. FIG. 21A shows a total photo-count rate (PCR) and dark count rate (DCR) for the West and East columns. For this measurement, the counting electronics were triggered on the West (or East) column amplifier output. Thus, the count rate was the sum of the count rates of single photon detectors in a same column.

The West column had a switching current (ISW) of 15 μA, with a cutoff current (Ico, the current at the inflection point of the PCR vs. bias curve) of 9 μA. The DCR is less than 1 counts/s except above 90% of ISW, where it slowly increased to −1 kcps at ISW. The East column has a switching current of 18.9 μA. The DCR for the East column was less than 1 counts/s below 80% of ISW and increased to 25 counts/s at ISW. A maximum count rate for the West column was approximately twice the maximum count rate of the East column due to misalignment of the chip relative to the fiber so that the West column received a higher photon flux than the East column.

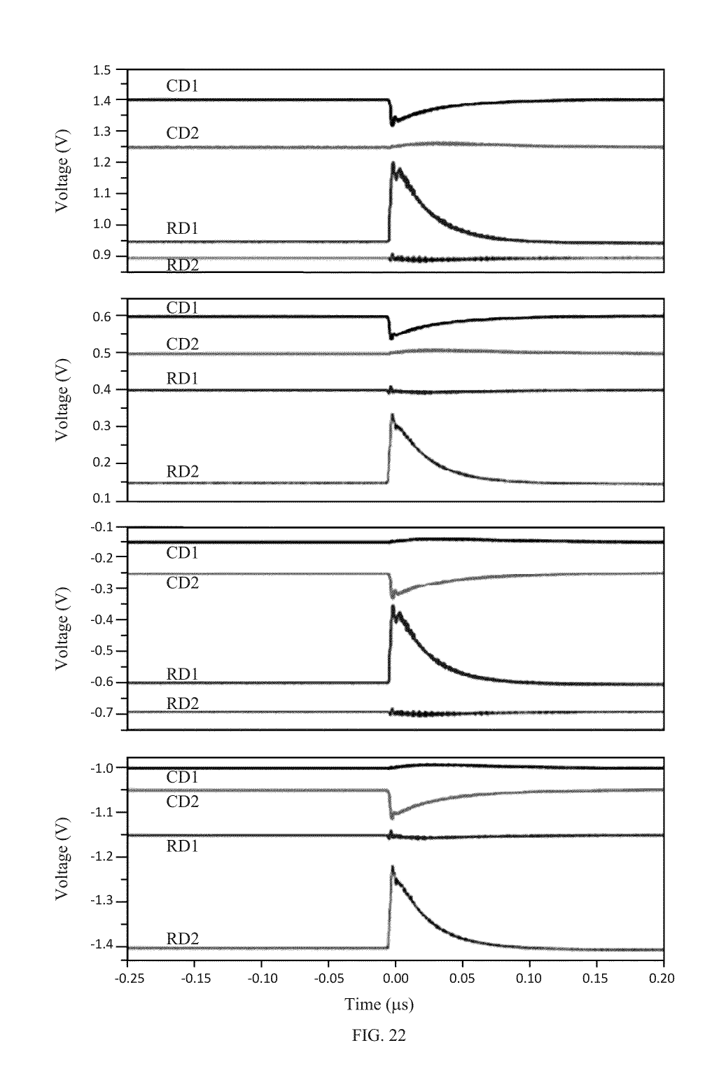

FIG. 22 shows averaged voltage pulse traces for the North, South, East, and West amplifiers output at CD1, CD2, RD1, and RD2 that were triggered on single-photon detection events in the NE (topmost graph), NW (second topmost graph), SE (penultimate graph), and SW (bottom) quadrants of the multiplexer. To obtain these curves, an oscilloscope was connected at outputs (CD1, CD2, RD1, RD2) and was triggered on a logical AND (̂) of two of the four inputs (i.e., N̂E, N̂W, and the like). Bias currents of the West and East columns were set at 13 μA and 18 μA, respectively. As shown in FIG. 22, voltage pulses from the North and South outputs (CD1 and CD2) were negative with a peak of 60 mV and a 1/e decay time of 34 ns. Voltage pulses from the West and East column outputs (RD1 and RD2) were positive with magnitudes of 180 mV and 246 mV and 1/e decay times of 24 ns.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. A multiplexer comprising:
a plurality of single photon detectors arranged in a two-dimensional array;
a plurality of first bias lines in electrical communication with the single photon detectors;
a plurality of second bias lines in electrical communication with the single photon detectors;
a plurality of first readout lines in electrical communication with the single photon detectors; and
a plurality of second readout lines in electrical communication with the single photon detectors,
wherein, for every single photon detector, the first bias line is in electrical communication with the first readout line in a first common line, and
for every single photon detector, the second bias line is in electrical communication with the second readout line in a second common line such that
the multiplexer is configured for current splitting.

2. The multiplexer of claim 1, wherein a total number of the single photon detectors is greater than a total number of the second common lines.

3. The multiplexer of claim 2, wherein the total number of the single photon detectors is equal to a total number of the first common lines.

4. The multiplexer of claim 1, wherein a total number of the single photon detectors is greater than a total number of the first common lines.

5. The multiplexer of claim 4, wherein the total number of the single photon detectors is equal to a total number of the second common lines.

6. The multiplexer of claim 4, wherein a total number of the single photon detectors is greater than a total number of the second common lines.

7. The multiplexer of claim 6, wherein the two dimensional array is an n×m array,
wherein n is an integer number of rows of single photon detectors, and m is an integer number of columns of single photon detectors

8. The multiplexer of claim 7, wherein n is greater than 1, and m is greater than 1.

9. The multiplexer of claim 8, wherein n is different than m.

10. The multiplexer of claim 8, wherein n=m.

11. The multiplexer of claim 8, wherein the total number of the single photon detectors is equal to n×m.

12. The multiplexer of claim 11, wherein the sum of the number of the first common lines and the number of the second common lines is equal to n+m.

13. The multiplexer of claim 8, wherein the total number of the single photon detectors is less than n×m.

14. The multiplexer of claim 13, wherein the sum of the number of the first common lines and the number of the second common lines is equal to n+m.

15. The multiplexer of claim 13, wherein the sum of the number of the first common lines and the number of the second common lines is less than n+m.

16. The multiplexer of claim 6, wherein the first common line comprises a first resistor in electrical communication with the single photon detector; and
the second bias line comprises a second resistor in electrical communication with the single photon detector.

17. The multiplexer of claim 16, wherein the first bias line further comprises an inductor in electrical communication with the first resistor and the single photon detector.

18. The multiplexer of claim 16, further comprising a plurality of first amplifiers electrically connected to the plurality of first readout lines and configured to receive a first voltage pulse from the plurality of single photon detectors, wherein the multiplexer is configured to provide information about a first relative position of a single photon incident on the two dimensional array, based on a specific first amplifier having received the first voltage pulse.

19. The multiplexer of claim 18, further comprising a plurality of second amplifiers electrically connected to the plurality of second readout lines and configured to receive a second voltage pulse from the plurality of single photon detectors, wherein the multiplexer is configured to provide information about a second relative position of the single photon incident on the two dimensional array, based on a specific second amplifier having received the second voltage pulse.

20. The multiplexer of claim 16, further comprising a plurality of current sources in electrical communication with the plurality of first bias lines and configured to provide a bias current to the plurality of first bias lines, the bias current comprising a direct current bias current.

21. The multiplexer of claim 1, wherein the single photon detector comprises a superconducting nanowire single photon detector.

22. The multiplexer of claim 7, wherein the multiplexer is configured to detect a spatial position of a photon incident at a specific single photon detector of the plurality of photon detectors via a combination of a first voltage pulse from an i^{th}-row and a second voltage pulse from a j^{th}-column of the two dimensional array,
wherein i is an integer that is less than or equal to n, and j is an integer that is less than or equal to m.

23. A process for making a multiplexer, the process comprising:
disposing a plurality of first resistors on a substrate;
disposing a plurality of single photon detectors on the substrate, each of the first resistors being in electrical communication with one of the single photon detectors;
disposing a plurality of inductors on the substrate, each of the inductors being in electrical communication with one of the first resistors and one of the single photon detectors;
forming a plurality of first bias lines in electrical communication with the single photon detectors and comprising the first resistors and the inductors;
forming a plurality of first readout lines in electrical communication with the single photon detectors, each of the first readout lines being in electrical communication with one of the first bias lines;
forming a plurality of second bias lines in electrical communication with the single photon detectors; and
forming a plurality of second readout lines in electrical communication with the single photon detectors to form the multiplexer, each of the second readout lines being in electrical communication with one of the second bias lines.

24. The process of claim 23, wherein the single photon detector comprises a superconducting nanowire.

25. The process of claim 24, wherein the superconducting nanowire comprises a superconductor.

26. The process of claim 23, wherein the substrate comprises a silicon, sapphire, quartz, glass, diamond, or a combination comprising at least one of the foregoing.

27. A process for detecting a single photon, the process comprising:
receiving the single photon by a multiplexer comprising a two dimensional array of single photon detectors;
producing a first voltage pulse in response to a state change of a specific single photon detector that received the single photon; and
producing a second voltage pulse in response to the state change of the specific single photon detector that received the single photon to detect the single photon.

28. The process of claim 27, further comprising cooling the multiplexer to attain a temperature of the single photon detectors that is less than or equal to 250 mK.

29. The process of claim 27, further comprising determining a relative position on the two dimensional array of the single photon based on the first voltage pulse and the second voltage pulse.

30. The process of claim 27, wherein the multiplexer comprises:
a plurality of the single photon detectors arranged in the two-dimensional array;
a plurality of first bias lines in electrical communication with the single photon detectors;
a plurality of second bias lines in electrical communication with the single photon detectors;
a plurality of first readout lines in electrical communication with the single photon detectors; and
a plurality of second readout lines in electrical communication with the single photon detectors,
wherein, for every single photon detector, the first bias line is in electrical communication with the first readout line in a first common line, and
for every single photon detector, the second bias line is in electrical communication with the second readout line in a second common line such that
the multiplexer is configured for resistive current splitting.
